(19) United States
(12) Patent Application Publication
(10) Pub. No.: US 2026/0105540 A1
(43) Pub. Date: Apr. 16, 2026

(54) METHOD AND SYSTEM FOR DYNAMIC CATEGORIZATION OF UTILITY BILL DATA

(71) Applicant: Honeywell International Inc., Charlotte, NC (US)

(72) Inventors: Manojsingh Bajrangsingh Dobwal, PUNE (IN); Harish Kumar Hallera Shivakumar, Bangalore (IN); Jayanth Thyagarajan, Tiruchirappalli (IN); Devodyuti Mukherjee, Kolkata (IN)

(21) Appl. No.: 18/914,308

(22) Filed: Oct. 14, 2024

(51) Int. Cl. G06Q 50/06; G06Q 30/04

(52) U.S. Cl. CPC G06Q 50/06; G06Q 30/04

(57) ABSTRACT

A method and system for processing utility bill data using artificial intelligence (AI) is disclosed, to provide real-time analysis and dynamic categorization. The method comprises retrieving utility bill data from various sources, including utility providers and smart meters, and classifies the data into multiple categories, such as consumption, demand, service charges, and transmission and distribution costs. The categorized data is normalized for consistency across different billing formats, allowing users to easily compare and analyze their utility bills. The method further comprises detecting anomalies, identifying seasonal consumption patterns, and providing recommendations for optimizing utility costs. Additionally, the method offers features such as pro-rata bill comparisons, anomaly detection alerts, and custom category creation to cater to a wide range of utility bill structures.

### TECHNICAL FIELD

The present disclosure relates to a system and method for processing utility bill data. More specifically, the present disclosure pertains to the use of artificial intelligence (AI) to dynamically classify, analyze, and extract insights from utility bill data in real-time.

### BACKGROUND

Utility bills, whether for electricity, water, gas, or other services, often follow complex pricing structures that can vary based on consumption levels, geographical regions, seasonal usage, and other factors. The challenge for consumers, businesses, and institutions lies in efficiently managing, analyzing, and understanding the utility data across various bill formats, sources, and services.

Existing systems for utility bill management often rely on templatized or fixed categorization approaches. These approaches lack the flexibility to adapt to the nuances of different utility providers and varying billing structures. For example, existing prior art solutions require manual input or predefined templates that classify utility bill data into rigid categories like “consumption” or “service charges.” This rigidity often leads to incomplete analysis and limits the ability to identify cost-saving opportunities, especially as billing practices evolve.

Another key limitation of conventional systems is their inability to analyze utility data in real-time. As the volume of data grows and consumption patterns become more complex, users need a system that can provide instantaneous insights, such as identifying unusual spikes in consumption or comparing usage across different time periods. Traditional systems often lack the computational power to dynamically process this data and fail to generate meaningful, timely insights for users.

Additionally, anomaly detection in existing systems is often rudimentary, limited to flagging large variances in monthly bills without deeper insights into consumption trends, demand usage, or cost contribution analysis. Users are not provided with a detailed understanding of why their bills may have increased or how they can optimize their usage to reduce future costs.

In light of these challenges, the integration of AI has opened up new possibilities in the realm of utility bill data processing. This creates an opportunity for a more advanced system that not only categorizes utility bill data dynamically but also offers actionable insights for reducing costs and optimizing usage.

### SUMMARY

The present disclosure presents a method and system that dynamically classifies utility bill data, normalizes the classified data for consistency, and generates real-time insights. By adapting to the specific characteristics of each bill, the system provides users with more accurate and detailed information. Additionally, the system includes advanced features such as anomaly detection, seasonal consumption comparison, and cost-saving recommendations, all presented through a user-friendly graphical interface.

In an embodiment, a method for processing utility bill data is disclosed. The method comprises retrieving the utility bill data from one or more sources using artificial intelligence (AI), and dynamically creating and classifying the retrieved utility bill data into a plurality of categories based on AI-driven analysis. The plurality of categories is generated in real-time based on characteristics of the utility bill data. The method further comprises normalizing the dynamically categorized utility bill data and storing the normalized utility bill data in a database, and extracting information from the normalized utility bill data. Furthermore, the method comprises displaying the extracted information to a user via a graphical user interface.

In some embodiment, the method further comprises detecting anomalies in the utility bill data based on predefined thresholds and alerting the user of potential issues comprising unusually high consumption or high charges.

In some embodiment, the method further comprises comparing the utility bill data across different seasons to identify seasonal consumption patterns and potential cost savings.

In some embodiment, the method further comprises generating a cash flow view based on the utility bill data, where the cash flow view includes detailed information on the amount, units, and CO₂ emissions for each billing period.

In some embodiment, the method further comprises dynamically creating custom categories based on specific characteristics of the utility bill data.

In some embodiment, the method further comprises providing the user with recommendations for reducing utility costs based on the extracted information, including suggestions for optimizing consumption and demand.

In some embodiment, the graphical user interface is further configured to display a normalized view of utility bills, calculated on a pro-rata basis, allowing the user to compare monthly consumptions, and costs over different periods.

In some embodiment, the plurality of categories comprises one or more of consumption, demand, service charges, transmission and distribution, and other charges.

In some embodiment, the extracted information comprises one or more of consumption trends, demand usage, cost contribution analysis, and anomaly detection.

In yet another embodiment, a system for processing utility bill data is disclosed. The system comprises an extraction module, a categorization module, a normalization module, a storage module, an analysis module, and a visualization module. The extraction module is configured to retrieve the utility bill data from one or more sources using artificial intelligence (AI). The categorization module is configured to dynamically classify the retrieved utility bill data into a plurality of categories based on AI-driven analysis. The plurality of categories is generated in real-time based on characteristics of the utility bill data. The normalization module is configured to normalize the dynamically categorized utility bill data. The storage module is configured to store the normalized utility bill data in a database. The analysis module is configured to extract information from the normalized utility bill data. The visualization module is configured to display the extracted information to a user via a graphical user interface.

In some embodiment, the analysis module is further configured to detect anomalies in the utility bill data based on predefined thresholds and alert the user of potential issues comprising unusually high consumption or high charges.

In some embodiment, the analysis module is further configured to compare the utility bill data across different seasons to identify seasonal consumption patterns and potential cost savings.

In the embodiment, the system further comprises a generation module configured to generate a cash flow view based on the utility bill data, where the cash flow view includes detailed information on the amount, units, and CO₂ emissions for each billing period.

In the embodiment, the system further comprises a creation module configured to dynamically create custom categories based on specific characteristics of the utility bill data.

In some embodiment, the visualisation module is further configured to provide the user with recommendations for reducing utility costs based on the extracted information, including suggestions for optimizing consumption and demand.

In some embodiment, the graphical user interface is further configured to display a normalized view of utility bills, calculated on a pro-rata basis, allowing the user to compare monthly consumptions, and costs over different periods.

In some embodiment, the plurality of categories comprises one or more of consumption, demand, service charges, transmission and distribution, and other charges.

In some embodiment, the extracted information comprises one or more of consumption trends, demand usage, cost contribution analysis, and anomaly detection.

In yet another embodiment, a non-transitory computer-readable medium is disclosed, having stored thereon computer-readable instructions that, when executed by a processor, cause the processor to execute a method for processing utility bill data. The process is configured to retrieve the utility bill data from one or more sources using artificial intelligence (AI), and dynamically create and classify the retrieved utility bill data into a plurality of categories based on AI-driven analysis. The plurality of categories is generated in real-time based on characteristics of the utility bill data. The processor is further configured to normalize the dynamically categorized utility bill data and store the normalized utility bill data in a database, and extract information from the normalized utility bill data. Furthermore, the processor is configured to display the extracted information to a user via a graphical user interface.

The disclosed method and system offer several advantages over existing solutions. The disclosed method and system provide dynamic categorization of the data, real-time analysis, and cost. The ability to generate categories on-the-fly allows for more flexible and accurate classification of utility bill data, ensuring that the system adapts to a wide variety of utility bill formats and structures. Further, AI-driven analysis enables the system to provide real-time feedback, anomaly detection, and insights to users, improving decision-making capabilities.

Furthermore, by comparing seasonal patterns and generating customized recommendations, the system helps users optimize their utility consumption, reducing costs. The graphical user interface presents data in a clear and normalized format, allowing users to easily understand their utility consumption patterns.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates a workflow of a system designed to process utility bill data, employing a Carbon and Energy Management (CEM) system according to an embodiment of the disclosure;

FIG. 2(a)-(b) illustrates samples of electricity utility bills, which emphasize key categories such as consumption, consumption cost, demand, and demand cost according to an embodiment of the disclosure;

FIG. 3 illustrates a detailed breakdown of utility bill insights according to an embodiment of the disclosure;

FIG. 4 illustrates the monthly and billing period views for electricity bill analysis according to an embodiment of the disclosure;

FIG. 5 illustrates utility bill breakdown insights according to an embodiment of the disclosure;

FIG. 6 illustrates an embodiment of electricity bill analysis that includes dynamically categorized information according to an embodiment of the disclosure;

FIG. 7 illustrates another embodiment of electricity bill analysis, focusing on the dynamic categorization of utility bill data according to an embodiment of the disclosure;

FIG. 8 illustrates a method for processing utility bill data according to an embodiment of the disclosure;

FIG. 9 illustrates a system for processing utility bill data according to an embodiment of this disclosure; and

FIG. 10 illustrates a schematic diagram of another communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

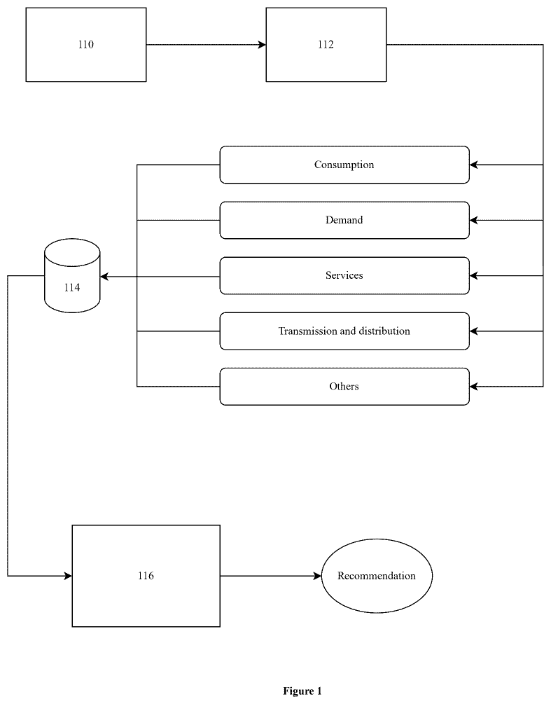

FIG. 1 illustrates the workflow of a system designed to process utility bill data, employing a Carbon and Energy Management (CEM) system 112 to fetch, categorize, store, analyze, and provide recommendations based on utility bill information. The FIG. 1 breaks down the process into key components: interaction with third-party utility service providers 110, categorization of utility data, storage in a centralized database 114, analysis via a bill dashboard 116, and the generation of cost-reduction recommendations for the end user.

The third-party utility service provider 110 represents external sources from which the utility bill data is retrieved. These could include electricity companies, water suppliers, gas providers, or other utility services that deliver consumption and billing data to the system 112.

The third-party utility service provider 110 acts as the origin of raw bill data, which may be in various formats and structures, depending on the utility provider's internal systems.

In an alternative embodiment of the disclosure, the utility service provider 110 responsible for delivering the utility bill data may be internal to the Carbon and Energy Management (CEM) system 112, rather than relying on external, third-party utility providers. This internal utility service provider can be integrated directly into the CEM system's architecture, allowing the system to handle both the generation and processing of utility data in a unified, streamlined manner.

In this embodiment, the CEM system 112 itself manages the provision of utilities such as electricity, water, or gas. The CEM system 112 generates utility bills based on real-time consumption data that is collected through internal sensors or smart meters installed at the user's premises. The utility data is collected continuously and fed into the CEM system 112, eliminating the need for external data acquisition from third-party service providers 110. This integrated setup provides several advantages, such as real-time updates on consumption patterns and faster anomaly detection due to the close interaction between data collection and processing systems.

The CEM System 112 is the core engine that processes and organizes the utility bill data. The CEM System 112 is responsible for retrieving data from multiple third-party utility providers. Once the data is fetched, the CEM system 112 uses Artificial Intelligence (AI) and data processing techniques to dynamically categorize the utility bill data. These categories include consumption, demand, services, transmission and distribution, and others categories. The consumption represents the amount of utility (electricity, water, gas) consumed by the user. The demand represents the peak consumption or the rate at which the utility is consumed. The services refer to additional charges related to the utility, such as service fees or meter charges. The transmission and distribution represent costs related to the delivery and infrastructure required to provide the utility service. The others represent any other miscellaneous charges or components of the utility bill.

The CEM database 114 stores the normalized and categorized data after processing. Once the utility bill data has been categorized into various components by the CEM system 112, it is stored in this CEM database 114 for further use. The CEM database 114 ensures that all utility data from different service providers 110 is standardized (normalized), regardless of the format in which the data was originally received. This normalization helps maintain consistency, allowing for accurate analysis and comparisons across different time periods or providers.

The Bill Analysis Dashboard 116 is the interface through which the stored and categorized data is displayed to the user. The Bill Analysis Dashboard 116 presents a detailed view of utility consumption, demand patterns, cost breakdowns, and other key metrics. Users can interact with the dashboard to view past billing data, compare usage across different months or seasons, and detect any anomalies in their utility consumption. The dashboard helps users understand where their money is being spent and which factors are contributing to higher utility bills.

Based on the categorized and analyzed data, the CEM system 112 provides recommendations to the user. These recommendations are aimed at optimizing utility usage and reducing costs. For instance, the CEM system 112 could suggest ways to lower consumption during peak demand periods, alert the user to any unusual spikes in usage, or offer advice on how to reduce service or transmission costs. These recommendations are customized based on the individual user's consumption patterns and the data stored in the CEM database 114.

An embodiment of the disclosure could involve real-time categorization of utility data as it is received from the utility provider. The system categorizes the data into predefined categories (such as consumption, demand, etc.), dynamically adjusting these categories based on the characteristics of the incoming data. For example, if a user's consumption shows a sudden spike during specific hours of the day, the system might create a sub-category of “peak-hour consumption” within the broader “consumption” category.

The CEM system 112 can further compare utility data across different seasons or months. For instance, during summer, electricity consumption might increase due to air conditioning usage. The CEM system 112 can highlight these trends to the user, allowing them to anticipate future utility bills and implement cost-saving strategies, such as using energy-efficient appliances or altering their usage patterns.

Another embodiment involves the system's ability to detect anomalies in the data. For example, if the CEM system 112 identifies a significant increase in consumption without a corresponding explanation (such as a seasonal change), it can alert the user to potential issues such as leaks in water pipes or malfunctioning appliances that consume excessive electricity. These alerts help users mitigate unexpected costs.

Based on the categorized data, the CEM system 112 provides actionable recommendations, such as suggesting the user switch to a different utility plan that better suits their consumption patterns. The CEM system 112 may also recommend installing energy-saving devices or suggest ways to reduce demand charges by spreading out consumption over non-peak hours.

The CEM system's capability to display a normalized view of utility bills is an embodiment that helps users make apples-to-apples comparisons. For instance, if a user moves from one residence to another or switches utility providers, the CEM system 112 normalizes the data across different billing formats, providing a seamless comparison of consumption and costs across different time periods.

The CEM system 112 could provide insights into the carbon footprint of the user's energy consumption. By tracking CO₂ emissions linked to their utility usage, the CEM system can offer recommendations for reducing their environmental impact. For example, the CEM system could suggest energy-saving strategies that align with greener practices or compare the CO₂ emissions across different billing periods.

A comprehensive system for managing utility bill data is showcased in FIG. 1, driven by AI-based dynamic categorization, real-time data analysis, and user-friendly recommendations. The CEM system 112 provides an end-to-end solution, from data retrieval from third-party service providers to delivering actionable insights and recommendations aimed at optimizing energy usage and reducing costs. Through embodiments such as seasonal analysis, anomaly detection, and environmental impact assessment, this system empowers users to take control of their utility expenditures while contributing to energy conservation efforts.

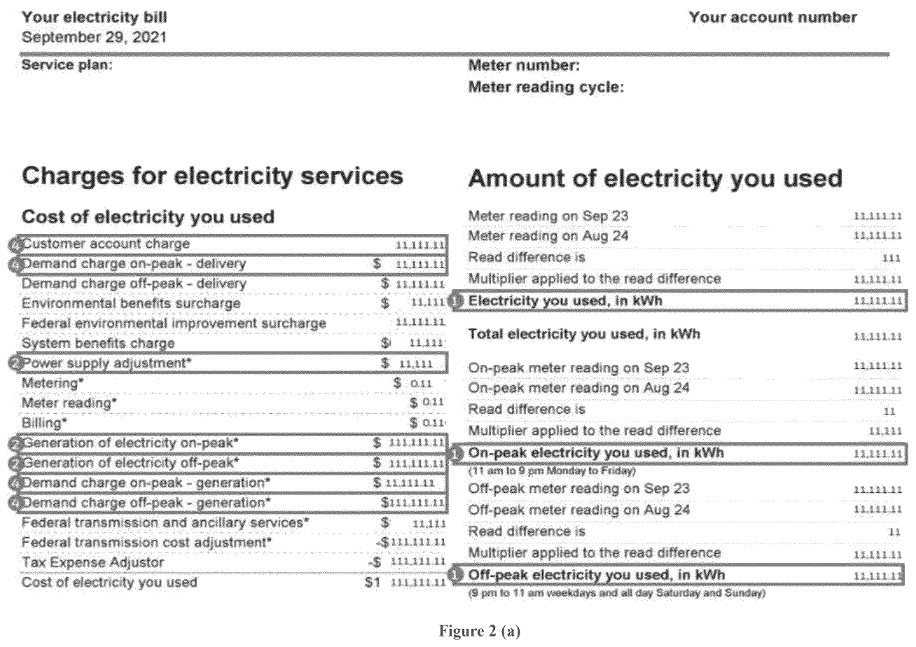

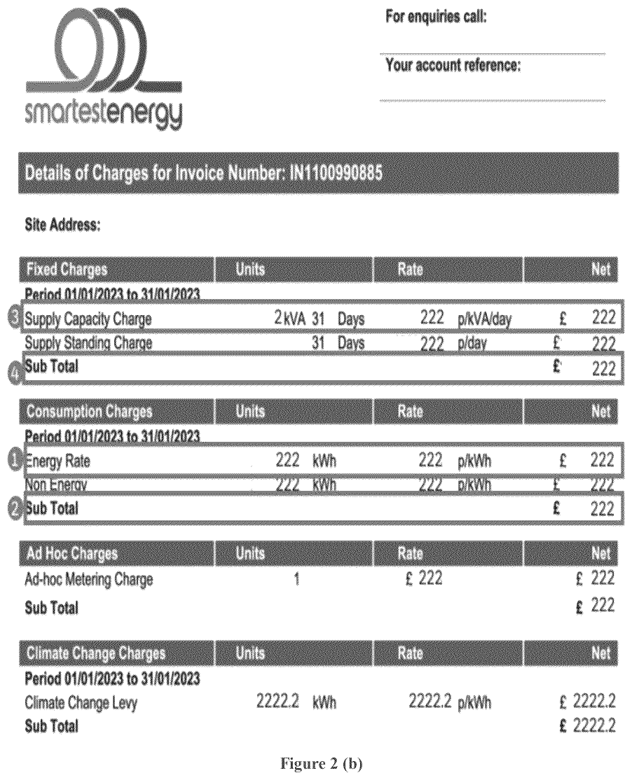

FIG. 2(a)-(b) illustrates samples of electricity utility bills, which emphasize key categories such as consumption, consumption cost, demand, and demand cost. These categories represent typical charges that customers incur for their electricity usage during a billing period. The third-party utility service provider 110 stores such data and makes it available to the CEM system 112.

The CEM system 112 retrieves the utility bill data using an AI-driven retrieval mechanism that automates the data acquisition from third-party utility providers. Once the data is fetched, the CEM system 112 processes it to dynamically categorize and organize the utility bill components. This includes classifying the retrieved data into key bill elements such as energy consumption, peak demand, service charges, and distribution costs. These categories are processed in real-time and are further normalized to ensure consistency across different utility bills.

After categorization, the data is stored in the CEM database 114, where it can be analyzed and displayed to the user in a structured format, providing insights such as trends in consumption, demand usage, and cost analysis. The CEM system 112 may also generate personalized recommendations for optimizing energy usage and reducing costs based on the categorized and analyzed data.

In an embodiment, the CEM system 112 retrieves utility bill data from third-party service providers and organizes it into predefined categories for further analysis. These categories include consumption, demand, service charges, and other charges. In consumption category, the CEM system 112 categorizes energy consumption based on usage during different time periods. In power supply adjustment, charges related to adjusting the power supply, typically reflecting supply variations is included. In generation of electricity on-peak, the cost of electricity consumed during peak demand periods, when electricity prices are generally higher is included. In generation of electricity off-peak, the cost of electricity consumed during off-peak periods, when demand and prices are lower is included.

The demand-related charges are categorized to show how peak and off-peak demand contribute to the overall bill. In demand charge on-peak-generation, the demand charge during peak periods based on the maximum energy demand within a billing cycle is included. In demand charge off-peak-Generation, the demand charge during off-peak periods is included.

In service charges, the system identifies various service charges associated with account management and utility service delivery, such as customer account charge, meter reading, and billing. The customer account charge is a fee for maintaining the customer's account. The meter reading charges for reading the utility meter. The billing charges associated with billing services provided by the utility.

In the other charges, these additional charges may include government-imposed fees and environmental surcharges, such as environment benefits surcharge, federal environmental improvement surcharge, system benefits charge, federal transmission and ancillary services, federal transmission and cost adjustment, tax expense adjustor, regulatory adjustment, state sales tax, county sales tax, city sales tax, and franchise fee.

In environmental benefits surcharge, fees to support environmental initiatives or improvements is included. In federal environmental improvement surcharge, a federal charge related to environmental improvements is included. In system benefits charge, a fee to fund public benefits such as energy efficiency programs is included. In federal transmission and ancillary services, charges related to transmission services and supporting infrastructure is included.

In federal transmission and cost adjustment, adjustment charges related to the cost of transmitting electricity is included. In the tax expense adjustor, adjustments for tax-related expenses is included. Regulatory adjustment includes charges related to regulatory compliance or adjustments. State sales tax includes tax levied by the state on the electricity consumed. The county sales tax includes a county-specific tax on the utility bill. The city sales tax includes a city-specific tax on the utility bill. The franchise fee includes a fee imposed by local governments for the right to provide utility services within a specific area.

In utility bill data, the system retrieves and processes utility bill data as follows: 1. start date: the beginning date of the billing cycle. 2. end date: the end date of the billing cycle. 3. amount: the total cost of the utility usage for the billing period. 4. units: the total units of electricity or energy consumed during the billing period. 5. CO₂ emission: the carbon emissions associated with the energy consumed during the billing period, which can be displayed to help users track their environmental impact.

For example, consider two sample billing cycles:

### Cycle 1: Aug. 24, 2021 to Sep. 23, 2021:

Amount: $16,632.28
Units: 225,808.00
CO₂ Emission: 64.15 metric tons

### Cycle 2: Sep. 24, 2021 to Oct. 23, 2021;

Amount: $22,228.91
Units: 298,879.00
CO₂ Emission: 84.91 metric tons

The system enables users to analyze their utility bill data on a daily basis to better understand their energy consumption and associated costs. Below is an example of how the system calculates bill inferences for the two aforementioned billing cycles.

### 1. Aug. 24, 2021-Sep. 23, 2021 Bill Data:

$$\begin{matrix}Number of Days = 31 days \\ Amount Per Day = \$16 , 632.28 / 31 = \$536 \text{.525} \\ Units Used Per Day = 225 , 808. / 31 = 7 , 284.129 \\ {CO}_{2} Emission Per Day = 64.15 / 31 = 2.069 metric tons\end{matrix}$$

### 2. Sep. 24, 2021-Oct. 23, 2021 Bill Data;

$$\begin{matrix}Number of Days = 30 days \\ Amount Per Day = \$22 , 228.91 / 30 = \$740 \text{.964} \\ Units Used Per Day = 298 , 879. / 30 = 9 , 962.633 \\ {CO}_{2} Emission Per Day = 84.91 / 30 = 2.83 metric tons\end{matrix}$$

The system allows for more detailed analysis by splitting billing periods: For example, September's billing period (1^{st}-23^{rd} and 24^{th}-30^{th}) can be computed as follows:

1^{st}-23^{rd} September (23 Days):

$$\begin{matrix}Amount = \$536 \text{.525} * 23 = \$12 , 340.075 \\ Units Consumed = 7 , 284.129 * 23 = 167 , 534.967 units \\ {CO}_{2} Emission = 2.069 * 23 = 47.587 metric tons\end{matrix}$$

24^{th}-30^{th} September (7 Days):

$$\begin{matrix}Amount = \$740 \text{.964} * 7 = \$5 , 186.745 \\ Units Consumed = 9 , 962.633 * 7 = 69 , 738.431 units \\ {CO}_{2} Emission = 2.83 * 7 = 19.81 metric tons\end{matrix}$$

The System can then Provide Total Amounts for the Entire Month of September:

$$\begin{matrix}Total Amount = \$12 , 340.075 + \$5 , 186.745 = \$17 , 526.82 \\ Total Units Used = 167 , 534.967 + 69 , 738.431 = 237 , 273.398 units \\ Total {CO}_{2} Emission = 47.587 + 19.81 = 67.397 metric tons\end{matrix}$$

In an embodiment, the system also provides normalized utility bill data for easy comparison across different billing periods. For example:

### Sep. 2021 (Sep. 1, 2021 to Sep. 30, 2021):

Amount: $17,526.820
Units: 237,273.398
CO₂ Emission: 67.397 metric tons

The Cash Flow View displays detailed information on the utility bill data, showing the start date, end date, amount, units consumed, and CO₂ emissions. This view allows users to track how their energy usage and associated costs vary across billing periods, helping them better manage their energy consumption and financial planning. The system can also suggest optimizations to reduce costs and carbon emissions based on the extracted data.

### For Instance, for the Billing Periods:

### Aug. 24, 2021 to Sep. 23, 2021:

Amount: $16,632.28
Units: 225,808.00
CO₂ Emission: 64.15 metric tons

### Sep. 24, 2021 to Oct. 23, 2021:

Amount: $22,228.91
Units: 298,879.00
CO₂ Emission: 84.91 metric tons

This cash flow view allows for quick visualization and interpretation of utility consumption and the associated financial impact over time, helping users optimize their energy usage for cost savings and environmental benefits.

Table 1 illustrates the mapping of the electricity bill to various categories. Table 2 demonstrates the categorization of the natural gas bill. Table 3 provides the mapping of the water bill to different categories. Finally, Table 4 outlines the sewer bill mapping to its respective categories.

TABLE 1

| | | Honeywell Mapping: | Honeywell Mapping: |
|---|---|---|---|
| Sr. No | Bill Category-3 | Category-2 | Category-1 |
| 1 | access_charge | Infrastructure Charge | Transmission & |
| | | | Distribution Cost |
| 2 | adjustments | Adjustments | Others |
| 3 | agl_pass_through_charges | Others | Others |
| 4 | ancillary_services | Service Charges | Service Charges |
| 5 | availability_charge | Infrastructure Charge | Transmission & |
| | | | Distribution Cost |
| 6 | basic_charge | Infrastructure Charge | Transmission & |
| | | | Distribution Cost |
| 7 | bill_issuance_charge | Service Charges | Service Charges |
| 8 | capacity_charge | Infrastructure Charge | Transmission & |
| | | | Distribution Cost |
| 9 | city_tax | Taxes | Others |
| 10 | cogeneration_tax | Renewable Energy | Others |
| 11 | collection_charge | Service Charges | Service Charges |
| 12 | compliance_charge | Regulatory Charges | Others |
| 13 | contract_amount | Others | Others |
| 14 | county_tax | Taxes | Others |
| 15 | credit_rebill | Adjustments | Others |
| 16 | customer_charge | Service Charges | Service Charges |
| 17 | demand_charge | Demand Charges | Demand Charges |
| 18 | deposit_request | Others | Others |
| 19 | discount | Others | Others |
| 20 | distribution_charge | Transmission & | Transmission & |
| | | Distribution Cost | Distribution Cost |
| 21 | energy_charge | Energy Cost | Consumption |
| 22 | energy_charge_intermediate_peak | Energy Cost | Consumption |
| 23 | energy_charge_off_peak | Energy Cost | Consumption |
| 24 | energy_charge_on_peak | Energy Cost | Consumption |
| 25 | energy_efficiency_cost_recovery | Regulatory Charges | Others |
| 26 | environmental_charge | Regulatory Charges | Others |
| 27 | excise_tax | Taxes | Others |
| 28 | feed_in_tariff_charge | Renewable Energy | Others |
| 29 | franchise_charge | Others | Others |
| 30 | fuel_cost_adjustment | Adjustments | Others |
| 31 | generation_service_charge | Service Charges | Service Charges |
| 32 | generation_services | Energy Cost | Consumption |
| 33 | goods_service_tax | Taxes | Others |
| 34 | green_energy_charge | Renewable Energy | Others |
| 35 | green_energy_tax | Regulatory Charges | Others |
| 36 | gross_receipts_tax | Taxes | Others |
| 37 | imbalance_charge | Fines & Penalties | Others |
| 38 | interest_on_deposit_certificate | Others | Others |
| 39 | late_fee | Fines & Penalties | Others |
| 40 | loss_charges | Others | Others |
| 41 | market_charge | Infrastructure Charge | Transmission & |
| | | | Distribution Cost |
| 42 | merger_transition_credit | Adjustments | Others |
| 43 | meter_data_service_charge | Others | Others |
| 44 | meter_maintenance_charge | Service Charges | Service Charges |
| 45 | meter_reading_charge | Service Charges | Service Charges |
| 46 | minimum_charge | Infrastructure Charge | Transmission & |
| | | | Distribution Cost |
| 47 | nuclear_charge | Regulatory Charges | Others |
| 48 | operation_round_up | Others | Others |
| 49 | other_charges | Adjustments | Others |
| 50 | other_cost_adjustment | Adjustments | Others |
| 51 | other_credit | Adjustments | Others |
| 52 | other_tax | Taxes | Others |
| 53 | penalty_charge | Others | Others |
| 54 | power_cost_adjustment | Energy Cost | Consumption |
| 55 | rate_adjustment | Others | Others |
| 56 | reactive_consumption_charge | Energy Cost | Consumption |
| 57 | reactive_demand_charge | Demand Charges | Demand Charges |
| 58 | recovery_surcharge | Others | Others |
| 59 | refund | Others | Others |
| 60 | renewable_energy_surcharge | Regulatory Charges | Others |
| 61 | renewable_obligation_charge | Regulatory Charges | Others |
| 62 | sales_tax | Taxes | Others |
| 63 | service_charge | Service Charges | Service Charges |
| 64 | settlement_charge | Adjustments | Others |
| 65 | standing_charge | Infrastructure Charge | Transmission & |
| | | | Distribution Cost |
| 66 | state_assessment | Regulatory Charges | Others |
| 67 | state_regulatory_tax | Regulatory Charges | Others |
| 68 | state_tax | Taxes | Others |
| 69 | supply_charge | Energy Cost | Consumption |
| 70 | system_benefit_fund | Regulatory Charges | Others |
| 71 | tax_charge | Taxes | Others |
| 72 | transition_charge | Others | Others |
| 73 | transmission_adjustment | Adjustments | Others |
| 74 | transmission_charge | Regulatory Charges | Others |
| 75 | transmission_cost_recovery | Transmission & | Transmission & |
| | | Distribution Cost | Distribution Cost |
| 76 | usage_charge | Energy Cost | Consumption |
| 77 | value_added_tax | Taxes | Others |

TABLE 2

| Sr. | | |
|---|---|---|
| No. | Bill Category-2 | Honeywell Mapping: Category-1 |
| 1 | adjustments | Others |
| 2 | agl_pass_through_charges | Others |
| 3 | basic_charge | Others |
| 4 | city_tax | Others |
| 5 | county_tax | Others |
| 6 | daily_charge | Others |
| 7 | decoupling_adjustment | Others |
| 8 | delivery_charge | Others |
| 9 | demand_charge | Demand Charge |
| 10 | discount | Others |
| 11 | distribution_adjustment_all | Others |
| 12 | excise_tax | Others |
| 13 | franchise_charge | Others |
| 14 | goods_service_tax | Others |
| 15 | green_energy_tax | Others |
| 16 | late_fee | Others |
| 17 | other_charges | Others |
| 18 | penalty_charge | Others |
| 19 | rate_adjustment | Others |
| 20 | refund | Others |
| 21 | sales_tax | Others |
| 22 | service_charge | Service Charge |
| 23 | state_tax | Others |
| 24 | supplier_refund | Others |
| 25 | supply_charge | Others |
| 26 | transportation_charge | Transmission & Distribution Cost |
| 27 | usage_charge | Consumption Charge |
| 28 | utility_tax | Others |
| 29 | value_added_tax | Others |

TABLE 3

| | | Honeywell Mapping: Category- |
|---|---|---|
| Sr. No. | Bill Category-2 | 1 |
| 1 | access_charge | Others |
| 2 | administrative_charge | Others |
| 3 | basic_charge | Others |
| 4 | city_tax | Others |
| 5 | credit_rebill | Others |
| 6 | disposal_charge | Others |
| 7 | environmental_charge | Others |
| 8 | fire_protection | Others |
| 9 | infrastructure_charge | Transmission & Distribution Cost |
| 10 | late_fee | Others |
| 11 | municipal_tax | Others |
| 12 | other_charges | Others |
| 13 | penalty_charge | Others |
| 14 | sales_tax | Others |
| 15 | sanitation_charge | Others |
| 16 | service_charge | Service Charge |
| 17 | sewer_charge | Others |
| 18 | state_tax | Service Charge |
| 19 | transportation_charge | Transmission & Distribution Cost |
| 20 | usage_charge | Consumption Charge |
| 21 | water_service_charge | Service Charge |
| 22 | credit_for_early_payment | Others |
| 23 | other_tax | Others |
| 24 | state_surcharge | Others |
| 25 | utility_tax | Others |

TABLE 4

| Sr. No. | Bill Category-3 | Honeywell Mapping: Category-2 |
|---|---|---|
| 1 | access_charge | Others |
| 2 | administrative_charge | Others |
| 3 | basic_charge | Others |
| 4 | city_tax | Others |
| 5 | credit_for_early_payment | Others |
| 6 | credit_rebill | Others |
| 7 | disposal_charge | Others |
| 8 | environmental_charge | Others |
| 9 | infrastructure_charge | Transmission & Distribution |
| 10 | late_fee | Others |
| 11 | municipal_tax | Others |
| 12 | other_charges | Others |
| 13 | penalty_charge | Others |
| 14 | sales_tax | Others |
| 15 | sanitation_charge | Others |
| 16 | service_charge | Service Charge |
| 17 | sewer_charge | Others |
| 18 | state_tax | Others |
| 19 | transportation_charge | Transmission & Distribution |
| 20 | usage_charge | Consumption Charge |
| 21 | water_service_charge | Service Charge |
| 22 | inspection_charge | Others |
| 23 | uncategorized_charge | Others |
| 24 | waste_water | Consumption Charge |

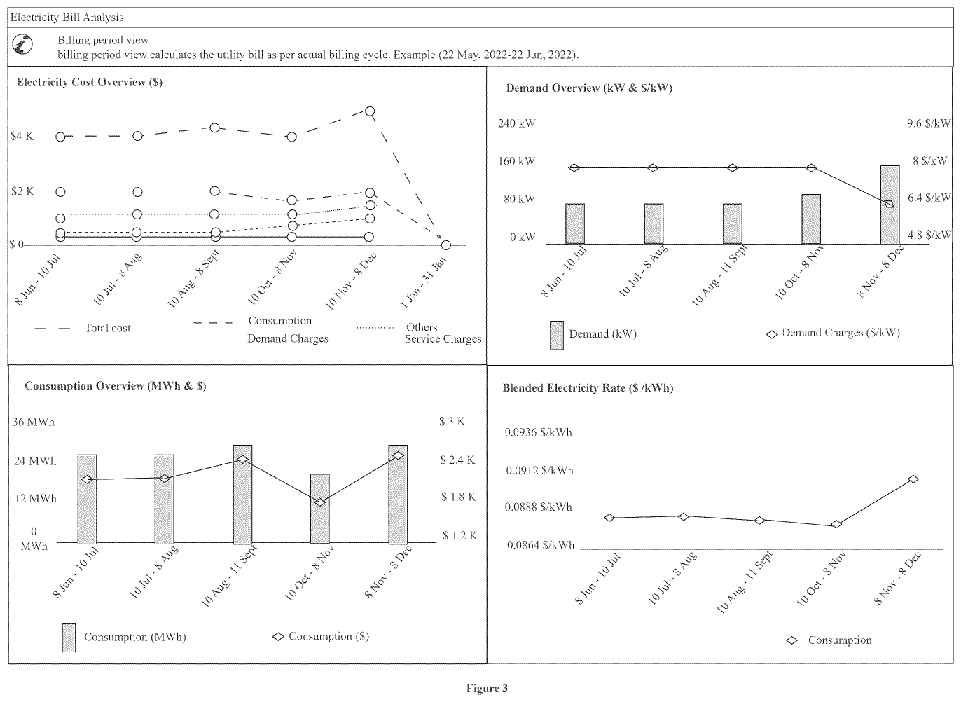

FIG. 3 illustrates a detailed breakdown of utility bill insights according to an embodiment of the disclosure. Specifically, it provides a comprehensive view of the billing period, where the utility bill is calculated based on the actual billing cycle. As shown in FIG. 3, for the billing period from May 22, 2022, to Jun. 22, 2022, the categorized data is presented in multiple segments, including an electricity cost overview, a consumption overview, demand overview, and a blended electricity rate.

The electricity cost overview breaks down the total cost, detailing charges for total cost, consumption, and other service-related fees. This enables users to clearly understand the factors contributing to the total cost of their electricity usage. The demand overview displays information about the demand charges versus the demand rate over a specific period.

The consumption overview provides insights into the actual amount of electricity consumed during the billing period, segmented across different time intervals if applicable (e.g., peak vs. off-peak consumption). This data helps users visualize their energy usage patterns and identify potential areas where consumption can be optimized.

Lastly, the blended electricity rate offers a combined view of the cost per unit of electricity consumed. This rate is calculated by dividing the total electricity cost by the total consumption, giving users an average cost per unit that reflects their overall consumption during the billing period.

This detailed breakdown of the utility bill allows users to gain meaningful insights into their energy usage, making it easier to track costs, identify inefficiencies, and explore opportunities for optimizing consumption to reduce future utility bills. The dynamic categorization of data in real-time, as shown in this figure, demonstrates the system's ability to adapt to varying utility data structures and provide clear, actionable information to the user.

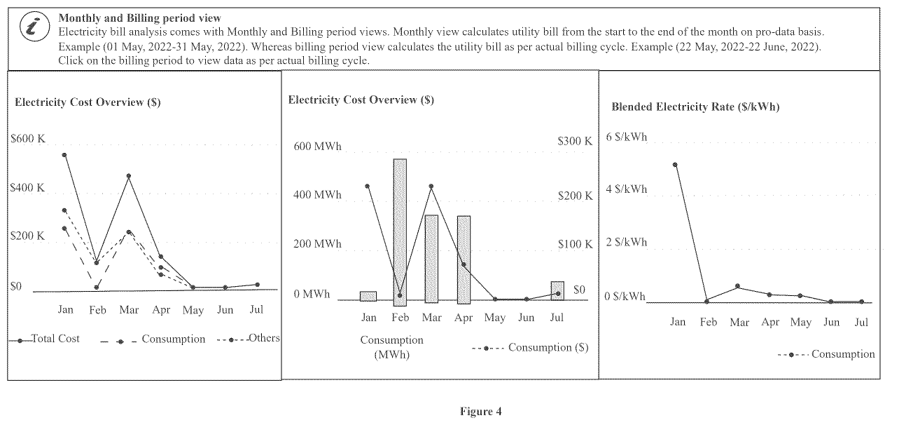

FIG. 4 illustrates the monthly and billing period views for electricity bill analysis according to an embodiment of the disclosure. The electricity bill analysis offers two distinct views: the monthly view and the billing period view.

The monthly view calculates the utility bills from the beginning to the end of each month on a pro-rata basis. For example, in the case of May 2022, the monthly view would calculate the utility usage and charges from May 1, 2022 to May 31, 2022. This view helps users track their electricity usage over consistent monthly intervals, enabling easier comparisons across different months.

On the other hand, the billing period view calculates the utility bill according to the actual billing cycle as defined by the utility provider. For instance, in the example of May 22, 2022 to Jun. 22, 2022, the billing period view reflects the specific time frame covered by the utility provider's billing system. This view gives users a more accurate reflection of the bill as received from their energy provider.

In one embodiment, the monthly view is set as the default view, providing a standardized approach for users to monitor their energy consumption and expenses across different months. However, users can easily switch to the billing period view by clicking on the relevant option in the interface, allowing them to review data based on the exact billing cycle provided by their utility company.

As depicted in FIG. 4, for the period from January to July, the categorized data is presented in several key segments, including an electricity cost overview, a consumption overview, and the blended electricity rate. The electricity cost overview shows the breakdown of various charges that contribute to the total bill, such as base consumption costs and any additional service fees.

The consumption overview illustrates the total electricity usage during the period, helping users visualize their consumption trends and identify any spikes or anomalies. The blended electricity rate provides a combined cost per unit of electricity consumed, calculated by dividing the total cost by the total consumption for the given period. This metric allows users to understand the average price they are paying per unit of electricity, giving them insights into pricing changes over time.

This comprehensive dual-view system offers users flexibility in how they view and analyze their utility data, providing both a high-level monthly summary and a detailed breakdown based on actual billing cycles. By offering both perspectives, the system empowers users to better manage and optimize their energy consumption and costs.

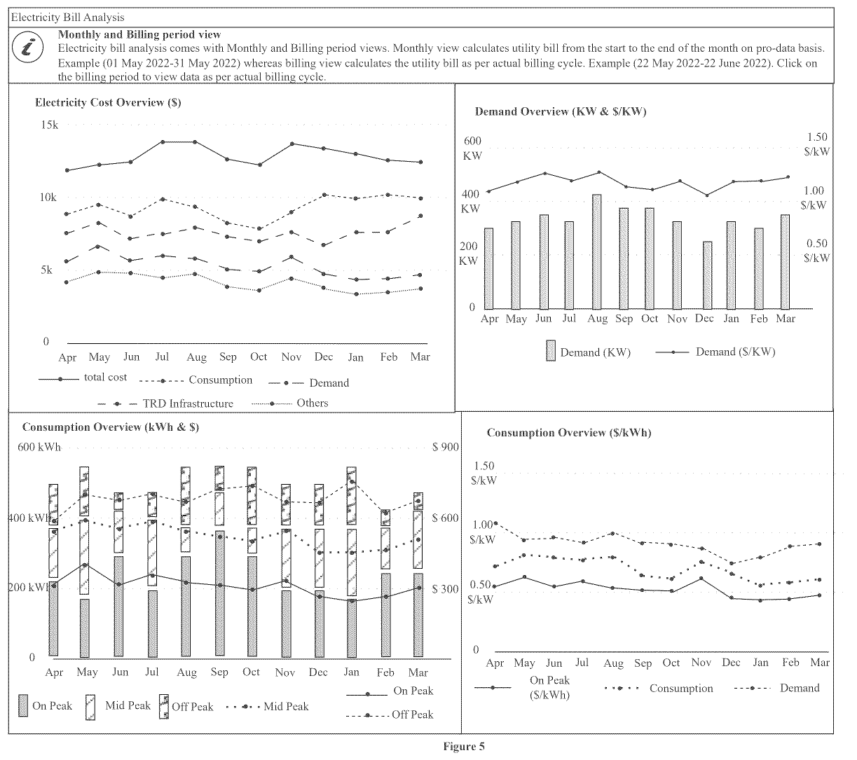

FIG. 5 illustrates utility bill breakdown insights according to an embodiment of the disclosure. Specifically, FIG. 5 presents both the monthly view and the billing period view for electricity bill analysis, similar to what has been discussed in FIG. 4. These two views offer distinct ways to interpret and analyze the utility bill data: the monthly view calculates bills from the start to the end of the month on a pro-rata basis, while the billing period view calculates the bill based on the actual billing cycle defined by the utility provider.

The view presented in FIG. 5 encompasses various key sections that provide detailed insights into the breakdown of the utility bill. These sections include an electricity cost overview, demand overview, consumption overview, consumption rate overview, a summary table, and a normalized view (monthly view).

The electricity cost overview provides a comprehensive breakdown of the various cost components that make up the total bill. For example, it details how much of the total bill cost is attributed to consumption, demand charges, service fees, and other relevant categories. Additionally, this overview offers trends over time, allowing the user to see changes in both the total bill amount and the individual cost components. This functionality helps users understand which elements of their electricity usage are driving costs and how these elements fluctuate over a given period.

The demand overview displays information about the demand charges versus the demand rate over a specific period. This view allows users to monitor their electricity demand in relation to the cost rate associated with that demand, making it easier to track fluctuations and manage their energy consumption based on demand charges.

The consumption overview breaks down the different components and subcategories of consumption that contribute to the total consumption charge on the bill. This section not only shows the overall consumption but also highlights the consumption of individual subcategories, along with their corresponding costs over time. It enables users to observe whether any new subcategories have been added or whether there have been significant changes in their consumption patterns over the selected period.

The consumption rate overview provides valuable insights by illustrating the relationship between consumption and the rate of consumption over a period. If the consumption rate changes, for example, due to a price increase in electricity rates, users can easily visualize how these changes impact the overall cost of their bill. This view allows users to track the direct correlation between fluctuating consumption rates and corresponding increases or decreases in their bills.

The summary table provides detailed billing information in a structured format, offering a more granular view of the data compared to the graphical representations. In contrast to the graph, which can also provide a pro-rata breakdown when in monthly view, the summary table delivers account-wise and meter-wise information on consumption, demand, and other charges. Users can use this table to see details at an account level, including service charges, taxes, and cost adjustments, which are only applicable at that level. Furthermore, the summary table allows users to download specific billing information for the selected account number, providing a quick and convenient reference.

The normalized view (also referred to as the monthly view) displays data that is normalized on a monthly, pro-rata basis. This means that the utility bills are calculated from the beginning of the month to the end of the month, giving users a standard way to compare their electricity usage and costs across different months. This view helps users better understand their energy consumption trends and provides a more consistent comparison across time periods, irrespective of the utility provider's actual billing cycle.

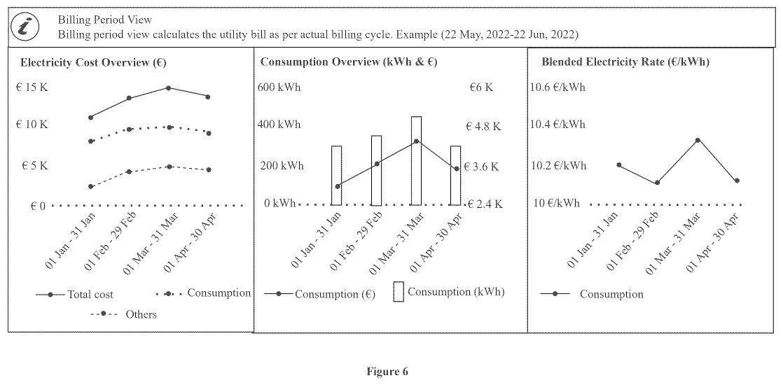

FIG. 6 illustrates an embodiment of electricity bill analysis that includes dynamically categorized information, as described in the disclosure. This figure focuses on the monthly view of the categorized utility bill data, presenting specific categories such as the electricity cost overview, consumption overview, blended electricity rate, and a summary table.

In this embodiment, FIG. 6 showcases how the system dynamically categorizes utility bill data in real-time based on the available information. The categorization process involves breaking down the various elements of the utility bill to offer the user detailed insights into their electricity usage and associated costs. Unlike FIG. 5, which provides a broader analysis that includes additional categories such as the demand overview, consumption rate overview, and a normalized view, FIG. 6 highlights a more streamlined analysis tailored to specific data available from different utility bills.

The electricity cost overview in this figure gives users a concise breakdown of the cost components that make up their total electricity bill, including the costs for electricity consumption and any service charges. This overview is particularly useful for understanding the overall distribution of costs within the bill.

The consumption overview provides insights into the user's electricity usage, detailing the amount of energy consumed during the billing period. It breaks down the total consumption into subcategories where applicable, allowing users to track their usage patterns and understand how their consumption impacts the total bill.

The blended electricity rate is another key feature in FIG. 6. This rate represents the average cost per unit of electricity consumed, considering various factors like peak and off-peak rates, and any applicable taxes or fees. This blended rate offers users a clearer picture of how their consumption translates into costs, making it easier to monitor changes in electricity prices over time.

The summary table provides a structured view of all the categorized data, summarizing the total cost, consumption details, and other relevant components in a user-friendly format. This table allows users to quickly reference key information at a glance, including comparisons between different periods or accounts, where applicable.

FIG. 6 presents an alternative analysis of the utility bill, focusing on a specific set of categories based on the information available from a particular utility provider. By dynamically adjusting the categories and presenting only the most relevant insights, this figure illustrates the system's ability to adapt to different billing formats and provide users with the most critical information needed to understand and manage their electricity usage and costs.

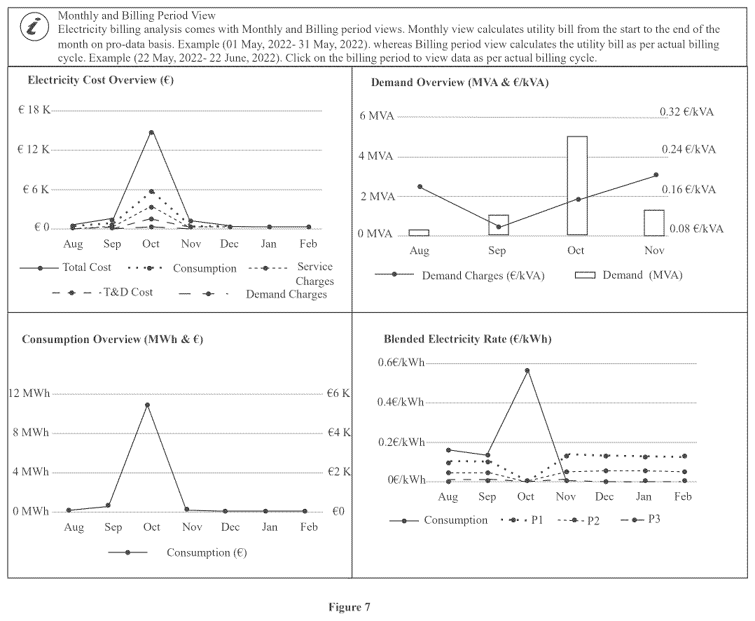

FIG. 7 illustrates another embodiment of electricity bill analysis, focusing on the dynamic categorization of utility bill data, as per an alternative embodiment of this disclosure. This figure showcases the system's ability to adapt to different billing formats by categorizing information in real-time, specifically tailored to the data available from a particular utility provider.

In this embodiment, the monthly view of the utility bill is presented, highlighting essential categories such as the electricity cost overview, demand overview, consumption overview, and the blended electricity rate. Each of these categories provides users with detailed insights into different aspects of their electricity bill, enabling a more customized understanding of their usage and costs.

The electricity cost overview in FIG. 7 focuses on the various cost components that constitute the total bill. This category breaks down the overall cost into key areas such as consumption cost, demand charges, and service fees, offering users a comprehensive look at where their spending is allocated.

The demand overview provides detailed information on electricity demand during the billing period, reflecting the highest points of consumption and how these peaks contribute to the overall demand charges. By tracking the demand rate and usage, users can identify patterns in their energy use, especially during high-demand periods, and understand how it impacts their costs.

The consumption overview gives a clear breakdown of the user's energy consumption for the billing period. This category may include subcategories, providing more granular details on specific types of consumption, such as peak vs. off-peak usage, appliance-specific consumption, or any other relevant data that helps users track their energy utilization over time.

The blended electricity rate reflects the average cost per unit of electricity consumed, considering various factors like peak pricing, taxes, and other applicable charges. This rate helps users see the combined effect of these factors on their bill, allowing them to understand how pricing fluctuations impact their overall costs.

FIG. 7 also emphasizes the system's ability to adapt dynamically to different utility bills. Depending on the available data, the system intelligently selects and categorizes the most relevant insights, ensuring that users are presented with the most pertinent information needed to effectively manage their electricity consumption and costs.

FIG. 7 demonstrates the flexibility and adaptability of the system in handling diverse billing formats by tailoring the categories of analysis to fit the specific characteristics of the utility bill data. By focusing on key areas such as electricity cost, demand, consumption, and blended rate, this embodiment provides users with a detailed and actionable view of their electricity usage, further enhancing their ability to optimize energy management.

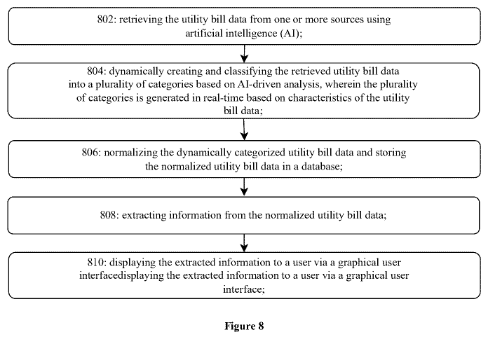

FIG. 8 illustrates a method for processing utility bill data according to an embodiment of this disclosure. The method begins at step 802, where utility bill data is retrieved from one or more sources utilizing artificial intelligence (AI). The AI is designed to autonomously collect the utility bill data from multiple sources, including utility providers, smart meters, and other external databases.

At step 804, the method involves dynamically creating and classifying the retrieved utility bill data into a plurality of categories. This classification is driven by AI-based analysis, which evaluates the utility bill data in real-time to determine the most relevant categories. The plurality of categories may include, but is not limited to, consumption, demand, service charges, transmission and distribution, and other charges. By dynamically generating categories based on the characteristics of the data, the system offers flexibility, adapting to various types of utility bills from different providers or sources.

At step 806, the method further comprises normalizing the dynamically categorized utility bill data and storing this normalized data in a database. The normalization process ensures that data from different sources or billing formats is standardized, making it easier to analyze and compare. This is especially critical when users manage multiple accounts or utility services, as it allows for a uniform understanding of the data.

Following normalization, at step 808, the method entails extracting information from the normalized utility bill data. In one embodiment, this extracted information may include insights such as consumption trends, demand usage, cost contribution analysis, and anomaly detection. These insights help users better understand their energy consumption patterns and pinpoint areas where they can improve efficiency. For instance, anomaly detection can flag unusually high energy usage, alerting the user to potential issues such as equipment malfunction or energy inefficiency.

At step 810, the method comprises displaying the extracted information to the user via a graphical user interface (GUI). The GUI presents the data in a user-friendly format, allowing users to visualize their energy consumption and related costs. In some embodiments, the GUI can also display a normalized view of utility bills, calculated on a pro-rata basis, enabling users to compare their monthly consumption and costs across different time periods.

In another embodiment, the method includes detecting anomalies in the utility bill data based on predefined thresholds, and alerting the user of potential issues. These issues could include unusually high consumption, spikes in demand, or unexpected charges. For example, if the AI detects a sudden surge in energy consumption outside of normal patterns, it will notify the user, allowing them to investigate the cause and take corrective actions.

Additionally, in some embodiments, the method comprises comparing the utility bill data across different seasons. This comparison is designed to identify seasonal consumption patterns and potential cost savings. For instance, the AI may determine that energy consumption spikes during summer months due to air conditioning usage, and provide recommendations for reducing energy consumption or shifting usage to off-peak hours to save costs.

The method further encompasses the generation of a cash flow view based on the utility bill data. This cash flow view includes detailed information on the amount, units of energy consumed, and CO₂ emissions for each billing period. Such a view enables users to not only track their financial expenditures but also assess their environmental impact, helping them make informed decisions about energy usage.

The method may also involve dynamically creating custom categories based on specific characteristics of the utility bill data. These custom categories allow users to tailor the analysis to their unique needs, such as breaking down energy usage by individual appliances, times of day, or specific facilities.

Lastly, the method comprises providing users with recommendations for reducing utility costs, based on the extracted information. These recommendations may include suggestions for optimizing consumption, such as shifting energy usage to non-peak times, investing in energy-efficient appliances, or even switching to alternative energy sources. Additionally, the system may provide insights on demand management, offering strategies for reducing peak demand and associated charges.

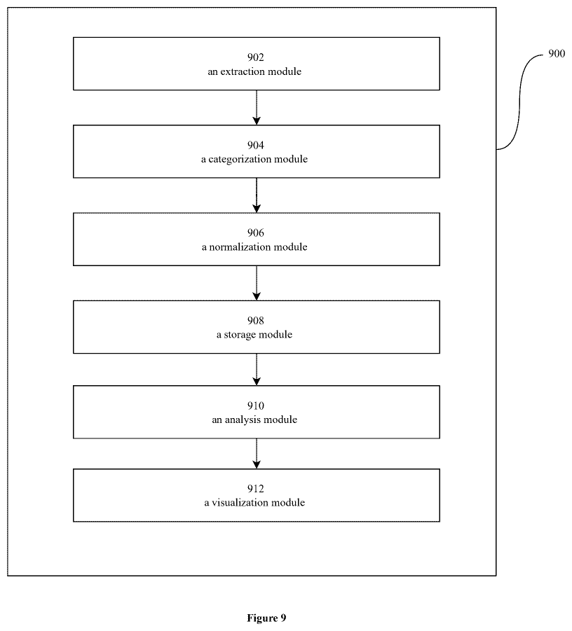

FIG. 9 illustrates a system 900 for processing utility bill data according to an embodiment of this disclosure. The system 900 comprises multiple integrated modules, each responsible for a distinct function in the data processing pipeline. These modules include an extraction module 902, a categorization module 904, a normalization module 906, a storage module 908, an analysis module 910, and a visualization module 912.

The extraction module 902 is configured to retrieve utility bill data from one or more sources utilizing artificial intelligence (AI). This AI-driven retrieval process enables seamless data collection from a wide range of sources, including utility providers, smart meters, and even third-party energy tracking services. By leveraging AI, the system 900 can ensure that the retrieved data is accurate, up-to-date, and relevant to the user. In an embodiment, the extracted data comprises consumption trends, demand usage, cost contribution analysis, and anomaly detection, all of which are vital for giving users a detailed overview of their utility usage.

The categorization module 904 dynamically classifies the retrieved utility bill data into a plurality of categories based on AI-driven analysis. The AI automatically detects the key characteristics of the utility data in real-time and assigns it to relevant categories. These categories may vary depending on the type of utility bill and the provider, ensuring flexibility in the system 900. In an embodiment, the plurality of categories includes, but is not limited to, consumption, demand, service charges, transmission and distribution costs, and other charges. For instance, the system 900 can classify data into specific cost components like peak demand charges or service fees, making it easier for users to understand where their expenses are coming from.

Once categorized, the normalization module 906 takes over, ensuring that the dynamically categorized utility bill data is standardized and comparable across different sources and formats. This process is crucial when users are handling data from various billing cycles, utility providers, or geographical locations. Normalization ensures consistency, allowing users to view and analyze their bills in a cohesive format, regardless of variations in data structure. For example, users who receive energy bills from multiple sources can have their data normalized to compare their usage on a uniform scale.

The storage module 908 is responsible for securely storing the normalized data in a database. This stored data can be retrieved for future analysis, enabling users to review historical utility data or track trends over time. The storage system also provides safeguards to ensure the data is protected from unauthorized access, thus maintaining the integrity and confidentiality of the user's billing information.

The analysis module 910 extracts critical insights from the normalized utility bill data. This module is capable of performing various analytical functions, such as identifying consumption trends and tracking cost contributions from different billing categories. In an embodiment, the analysis module 910 also detects anomalies in the utility bill data based on predefined thresholds. For example, if there is a sudden spike in consumption or charges that exceed normal expectations, the system 900 can alert the user allowing them to investigate the cause of the anomaly, such as a malfunctioning appliance or a misapplied rate.

In another embodiment, the analysis module 910 is further equipped to compare utility bill data across different seasons, enabling the identification of seasonal consumption patterns. This is particularly useful for users looking to optimize their energy use by understanding how their consumption fluctuates across seasons. For instance, high energy use during summer months due to air conditioning can be flagged, and the system 900 may offer suggestions on reducing usage or shifting consumption to off-peak times to achieve cost savings.

The final module in the system 900 is the visualization module 912, which is responsible for displaying the extracted information to the user through a graphical user interface (GUI). This GUI is designed to be intuitive and user-friendly, presenting data in a visual format that makes it easy for users to grasp the key insights from their utility bills. The visualization may include charts, graphs, and summary tables that break down consumption, demand, and costs over time. In one embodiment, the GUI is also configured to display a normalized view of utility bills, calculated on a pro-rata basis, which allows the user to compare their monthly consumption and costs across different billing periods. For example, if a user's billing cycle doesn't align with the calendar month, the normalized view can prorate the usage data so that the user can make meaningful month-to-month comparisons.

In addition to the real-time analysis, the system 900 may offer historical comparisons, allowing users to track long-term trends in their utility usage. This feature is particularly useful for businesses or property managers monitoring multiple utility accounts across different locations or time periods.

Through the combination of these modules, the system 900 provides a comprehensive and adaptive approach to utility bill analysis, accommodating the needs of a wide range of users-whether individuals looking to reduce household energy costs or businesses seeking to manage utility expenses across multiple sites. By dynamically categorizing, analyzing, and visualizing the data, the system 900 helps users optimize consumption, identify anomalies, and ultimately save on utility costs.

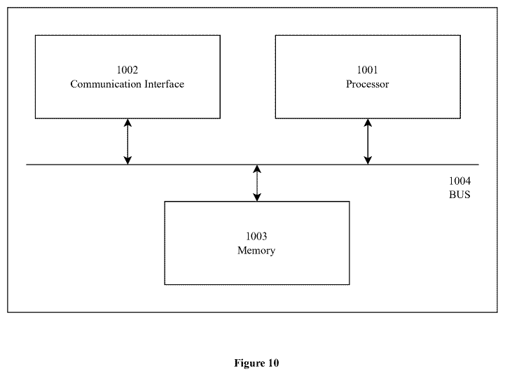

FIG. 10 illustrates a schematic diagram of another communication apparatus 1000 according to an embodiment of the disclosure. The communication apparatus 1000 includes a processor 1001, a communication interface 1002, and a memory 1003. The processor 1001, the communication interface 1002, and the memory 1003 may be connected to each other via a bus 1004. The bus 1004 may be a peripheral component interconnect (peripheral component interconnect, PCI) bus, an extended industry standard architecture (extended industry standard architecture, EISA) bus, or the like. The bus 1004 may be classified into an address bus, a data bus, a control bus, and the like. For ease of representation, the bus is represented by using only one line in FIG. 4, but it does not indicate that there is only one bus or one type of bus. The processor 1001 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 1003 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for processing utility bill data, comprising the steps of retrieving the utility bill data from one or more sources using artificial intelligence (AI);
dynamically creating and classifying the retrieved utility bill data into a plurality of categories based on AI-driven analysis, wherein the plurality of categories is generated in real-time based on characteristics of the utility bill data;
normalizing the dynamically categorized utility bill data and storing the normalized utility bill data in a database;
extracting information from the normalized utility bill data; and
displaying the extracted information to a user via a graphical user interface.

2. The method as claimed in claim 1, further comprising detecting anomalies in the utility bill data based on predefined thresholds and alerting the user of potential issues comprising unusually high consumption or high charges.

3. The method as claimed in claim 1, further comprising comparing the utility bill data across different seasons to identify seasonal consumption patterns and potential cost savings.

4. The method as claimed in claim 1, further comprising generating a cash flow view based on the utility bill data, wherein the cash flow view includes detailed information on the amount, units, and CO₂ emissions for each billing period.

5. The method as claimed in claim 1, further comprising dynamically creating custom categories based on specific characteristics of the utility bill data.

6. The method as claimed in claim 1, further comprising providing the user with recommendations for reducing utility costs based on the extracted information, including suggestions for optimizing consumption and demand.

7. The method as claimed in claim 1, wherein the graphical user interface is further configured to display a normalized view of utility bills, calculated on a pro-rata basis, allowing the user to compare monthly consumptions, and costs over different periods.

8. The method as claimed in claim 1, wherein the plurality of categories comprises one or more of consumption, demand, service charges, transmission and distribution, and other charges.

9. The method as claimed in claim 1, wherein the extracted information comprises one or more of consumption trends, demand usage, cost contribution analysis, and anomaly detection.

10. A system for processing utility bill data, comprising:
an extraction module configured to retrieve the utility bill data from one or more sources using artificial intelligence (AI);
a categorization module configured to dynamically classify the retrieved utility bill data into a plurality of categories based on AI-driven analysis, wherein the plurality of categories is generated in real-time based on characteristics of the utility bill data;
a normalization module configured to normalize the dynamically categorized utility bill data;
a storage module configured to store the normalized utility bill data in a database;
an analysis module configured to extract information from the normalized utility bill data; and
a visualization module configured to display the extracted information to a user via a graphical user interface.

11. The system as claimed in claim 10, wherein the analysis module is further configured to detect anomalies in the utility bill data based on predefined thresholds and alert the user of potential issues comprising unusually high consumption or high charges.

12. The system as claimed in claim 10, wherein the analysis module is further configured to compare the utility bill data across different seasons to identify seasonal consumption patterns and potential cost savings.

13. The system as claimed in claim 10, further comprising a generation module configured to generate a cash flow view based on the utility bill data, wherein the cash flow view includes detailed information on the amount, units, and CO₂ emissions for each billing period.

14. The system as claimed in claim 10, further comprising a creation module configured to dynamically create custom categories based on specific characteristics of the utility bill data.

15. The system as claimed in claim 10, wherein the visualisation module is further configured to provide the user with recommendations for reducing utility costs based on the extracted information, including suggestions for optimizing consumption and demand.

16. The system as claimed in claim 10, wherein the graphical user interface is further configured to display a normalized view of utility bills, calculated on a pro-rata basis, allowing the user to compare monthly consumptions, and costs over different periods.

17. The system as claimed in claim 10, wherein the plurality of categories comprises one or more of consumption, demand, service charges, transmission and distribution, and other charges.

18. The system as claimed in claim 10, wherein the extracted information comprises one or more of consumption trends, demand usage, cost contribution analysis, and anomaly detection.

19. A non-transitory computer-readable medium having stored thereon computer-readable instructions that, when executed by a processor, cause the processor to execute a method for processing utility bill data, comprising the steps of:
retrieving the utility bill data from one or more sources using artificial intelligence (AI);
dynamically creating and classifying the retrieved utility bill data into a plurality of categories based on AI-driven analysis, wherein the plurality of categories is generated in real-time based on characteristics of the utility bill data;
normalizing the dynamically categorized utility bill data and storing the normalized utility bill data in a database;
extracting information from the normalized utility bill data; and
displaying the extracted information to a user via a graphical user interface.

20. The non-transitory computer-readable medium as claimed in claim 19, wherein the computer-readable instructions further cause the processor to detect anomalies in the utility bill data based on predefined thresholds and alert the user of potential issues comprising unusually high consumption or high charges.
